(19) United States
(12) Patent Application Publication
(10) Pub. No.: US 2009/0218191 A1
(43) Pub. Date: Sep. 3, 2009

(54) CASH RECEIVER FOR CONSUMPTION SYSTEM

(75) Inventors: Chih-Hsu Tsai, Changhua Hsien (TW); Chen-Yen Chiu, Taipei City (TW); Hung-Yi Chang, Chilung City (TW); Po-An Chen, Taipei City (TW)

Correspondence Address: INTERNATIONAL CURRENCY TECHNOLOGIES CORPORATION, P.O.BOX 108-00403, TAIPEI, 106, omitted

(73) Assignee: INTERNATIONAL CURRENCY TECHNOLOGIES CORPORATION, Taipei City (TW)

(21) Appl. No.: 12/039,724

(22) Filed: Feb. 28, 2008

(51) Int. Cl. G07D 7/00; G07F 9/10; G07F 1/02

(52) U.S. Cl. 194/302; 194/350; 194/351

(57) ABSTRACT

A cash receiver installed in an amusement machine for controlling the operation of the machine, including a face panel that has a coin slot, a coin-return slot and a vertical bill slot, a coin receiver unit that is affixed to the rear side of the face panel and has a coin entrance passage connected to the coin slot and a coin-return passage connected to the coin-return slot, and a bill receiver unit that is affixed to the rear side of the face panel and abutted against one side of the coin receiver unit and has a bill passage connected to the vertical bill slot. The client can insert a coin or a bill into the cash receiver to play the amusement machine.

### BACKGROUND OF THE INVENTION

1. Field of the Invention

The present invention relates to a cash receiving device for used in a consumption system and more particularly, to a cash receiver for consumption system that accepts coins as well as bills.

2. Description of the Related Art

Following fast development of technology, the distance between people is becoming closer, and the rhythm of modern life is becoming faster. In consequence, modern people need convenience and rapidness. To satisfy people's need for convenience and rapidness, automatic vending machines are provided everywhere. Installation of automatic vending machines saves much labor cost and brings convenience to people. Q-shop provides three advantages, i.e., “technology intelligence”, “fast service” and “fast checkout”. It breaks through conventional sales mode. A Q-shop may provide vending machines to sell beverage, vehicle tickets, tobaccos, ice cream, theater tickets, memorial coins, key rings or even hamburger, French fries, noodles, etc. Following development of automatic vending machine technology, many new machines are created to sell different items. Many virtual shops are established to bring convenience to people. These virtual shops emphasize manless management and self-checkout, providing people with a totally different shopping experience.

Similar to the provision of automatic vending machines, game machines, photo-shooting machines and/or other amusement machines are commonly seen in shops as well as entertainment parks, amusement parks, recreational places, night markets, street corners and many other places. However, regular game machines and automatic vending machines simply accept coins. The owner of the place where game machines and/or automatic vending machines are provided may have to provide a money exchange service. Providing this service relatively increases the management cost.

Further, because coins are small-value money and heavy, people may be not willing to bring coins. When a people enters a manless-management amusement park and is going to play one particular facility, he (she) must prepare coins and insert coins into the coin slot of the facility. A manless-management amusement park may provide a coin change machine so that consumers can change a banknote into coins. However, a coin change machine has only a limited number of coins for exchange. When the coins of a coin change machine are all used up, the coin change machine can no longer provide the service. A consumer may feel upset if he (she) cannot change the money into coins. This inconvenience may cause the consumer not willing to visit the place again.

Therefore, how to overcome the problem that a consumption system accepts only coins and rejects banknote is an important subject to people running this business.

### SUMMARY OF THE INVENTION

The present invention has been accomplished under the circumstances in view. According one aspect of the present invention, the cash receiver is installed in a host for controlling the operation of the host. The host can be any of a variety of amusement machines. The cash receiver comprises a face panel that has a coin slot, a coin-return slot and a vertical bill slot, a coin receiver unit that is affixed to the rear side of the face panel and has a coin entrance passage connected to the coin slot and a coin-return passage connected to the coin-return slot, and a bill receiver unit that is affixed to the rear side of the face panel and abutted against one side of the coin receiver unit and has a bill passage connected to the vertical bill slot. The client can insert a coin into the coin slot or a bill into the bill slot to start the host for play.

According to another aspect of the present invention, the bill receiver unit comprises a bill acceptor module installed in the bill passage for verifying the authenticity and value of the inserted bill. When a counterfeit bill is inserted, the bill acceptor module will reject the counterfeit bill and return it to the bill slot.

By means of the application of the present invention, the consumption system can accept a coin as well as a bill and has a function to verify the authenticity of the inserted coin or bill, and therefore the owner of the consumption system needs not to worry about the risk of money washing by an evil person by means of the consumption system.

### BRIEF DESCRIPTION OF THE DRAWINGS

FIG. 1 is a perspective view of a consumption system equipped with a cash receiver according to the present invention.

FIG. 2 is an elevational view of a cash receiver in accordance with the present invention.

FIG. 3 is an exploded view of the cash receiver in accordance with the present invention.

FIG. 4 is an exploded view of the coin receiver unit of the cash receiver in accordance with the present invention.

FIG. 5 is an exploded view of the bill receiver unit of the cash receiver in accordance with the present invention.

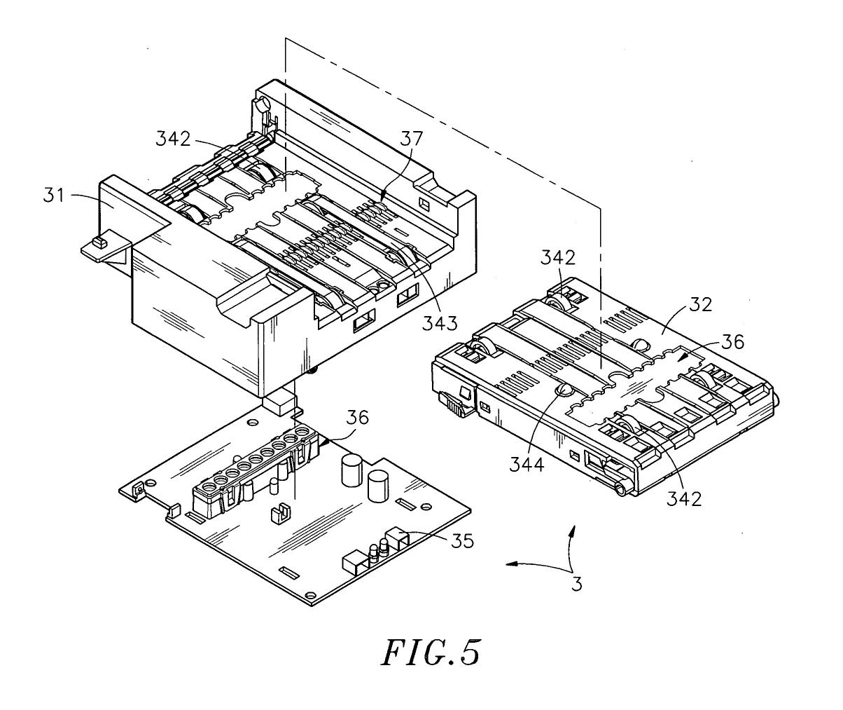

FIG. 6 is a top view of the bill receiver unit of the cash receiver in accordance with the present invention.

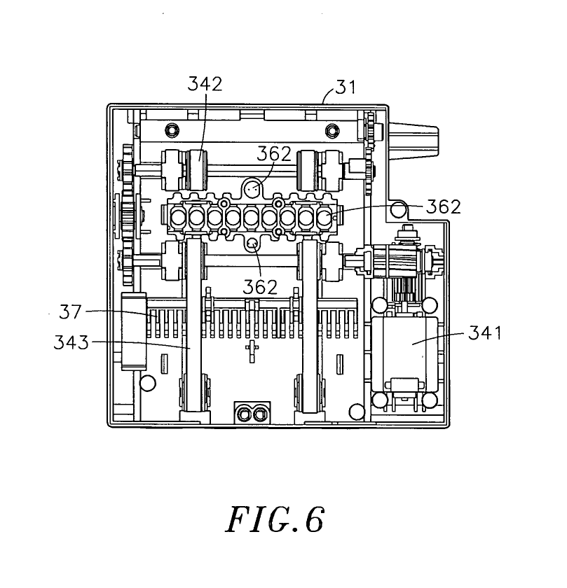

FIG. 7 is a sectional side view of the bill receiver unit of the cash receiver in accordance with the present invention.

FIG. 8 is a circuit block diagram of the control circuit according to the present invention.

FIG. 9 is a flow chart of the control circuit according to the present invention (I).

FIG. 10 is a flow chart of the control circuit according to the present invention (II).

FIG. 11 is an operation flow chart of the present invention (I).

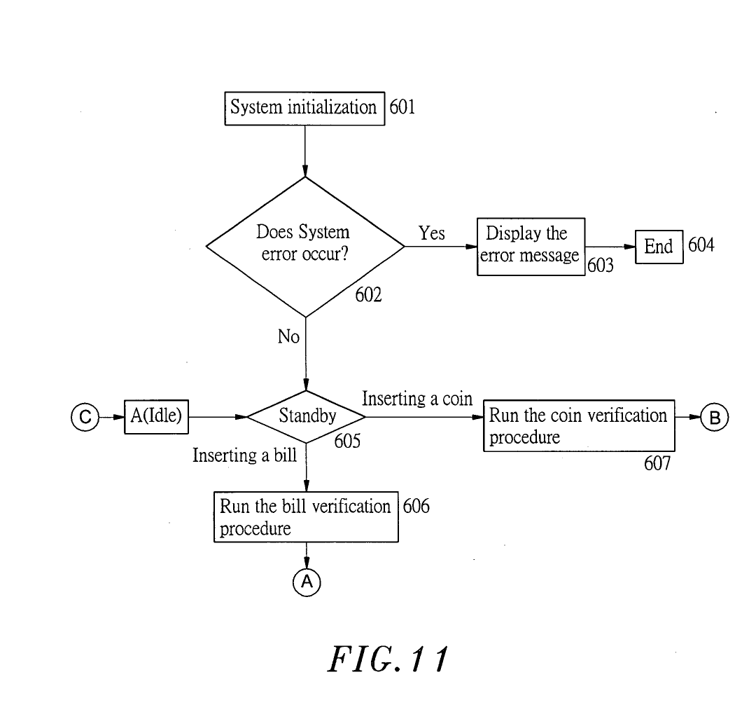

FIG. 12 is an operation flow chart of the present invention (II).

FIG. 13 is an operation flow chart of the present invention (III).

FIG. 14 shows another application example of the present invention.

FIG. 15 shows still another application example of the present invention.

### DETAILED DESCRIPTION OF THE PREFERRED EMBODIMENT

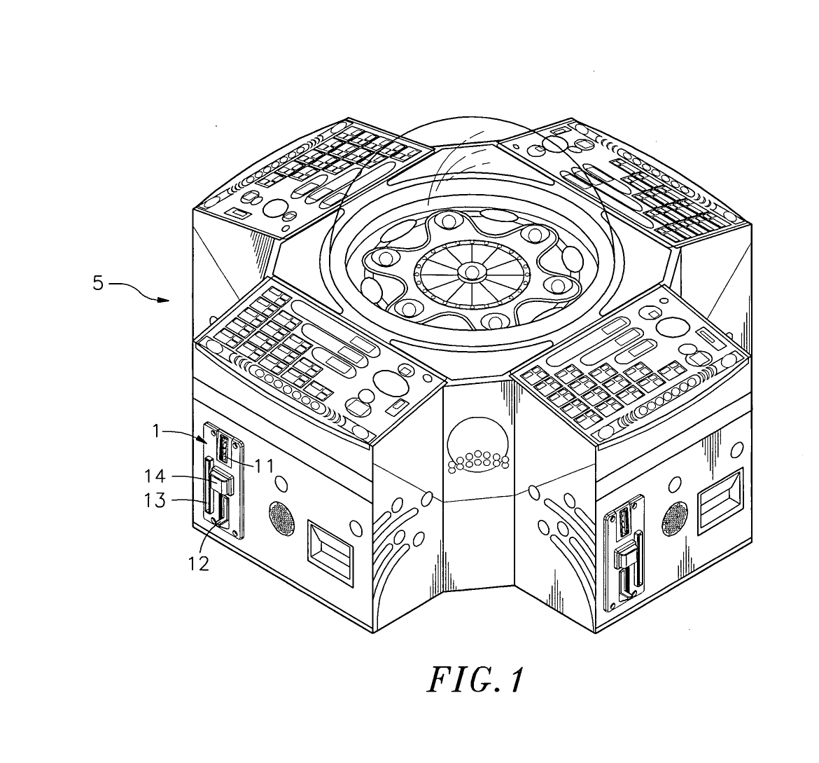

Referring to FIGS. 1˜7, a cash receiver in accordance with the present invention is shown installed in a host 5. The host 5 according to this embodiment is a consumption system. The cash receiver is comprised of a face panel 1, a coin receiver unit 2 and a bill receiver unit 3.

The face panel 1 comprises a coin slot 11 near the top, a coin-return slot 12 below the coin slot 11, a vertical bill slot 13 near one lateral side, and a coin-return button 14 at a suitable location, for example, between the coin slot 11 and the coin-return slot 12.

The coin receiver unit 2 comprises a base plate 21, a coin dispenser 22, a coin entrance passage 23 defined between the base plate 21 and the coin dispenser 22, a loop-coil detector circuit 24 installed in the coin entrance passage 23 and adapted to detect the authenticity and value of the inserted coin, an anti-theft security hook 25 disposed in the coin entrance passage 23 to prevent stealing of coins by a theft, an optical sensor 26 installed in the coin entrance passage 23 and adapted to detect the authenticity of each inserted coin, a coin-return passage 28 below the coin-entrance passage 23, an electromagnetic valve 27, a sliding gate 271 controllable by the electromagnetic valve 27 to close/open the passage between the coin entrance passage 23 and the coin-return passage 28.

The bill receiver unit 3 comprises a base frame 31, a cover 32 covering the base frame 31 and defining with the base frame 31 a bill passage 33, a motor drive mechanism 34 mounted in the bill passage 33, an interface circuit 35 for data transmission, a bill acceptor module 36 adapted to detect the authenticity and value of each inserted bill passing through the bill passage 33, and an anti-theft security hook 37 disposed in the bill passage 33 to prevent stealing of bills by a theft. The motor drive mechanism 34 is comprised of a motor 341, a plurality of transmission rollers 342, transmission belts 343 and rolling balls 344 for delivering each inserted bill through the bill passage 33.

During installation, the coin receiver unit 2 and the bill receiver unit 3 are abutted against each other and fixedly fastened to the back side of the face panel 1. After the cash receiver is assembled, the coin entrance passage 23 and the coin-return passage 28 of the coin receiver unit 2 and the bill passage 33 of the bill receiver unit 3 are respectively connected to the coin slot 11, the coin-return slot 12 and the bill slot 13 of the face panel 1. Thereafter, the cash receiver is installed in the host 5, keeping the coin receiver unit 2 and the bill receiver unit 3 on the inside of the host 5 and the face panel 1 on the outside of the host 5.

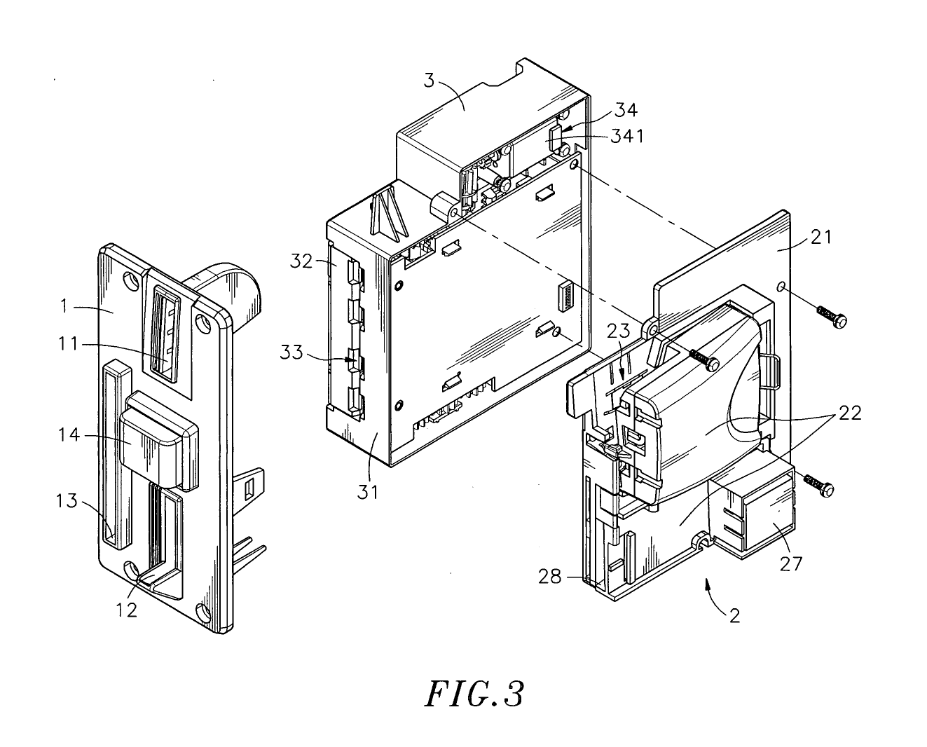

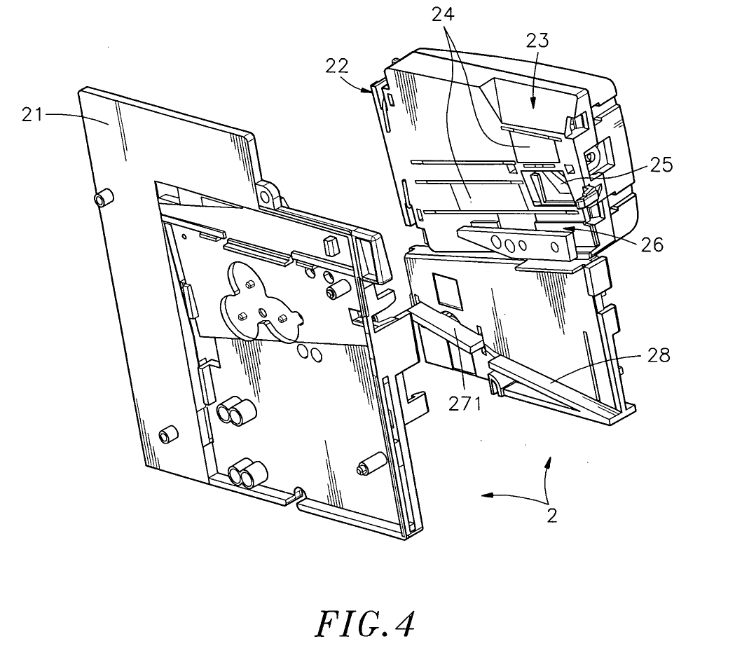

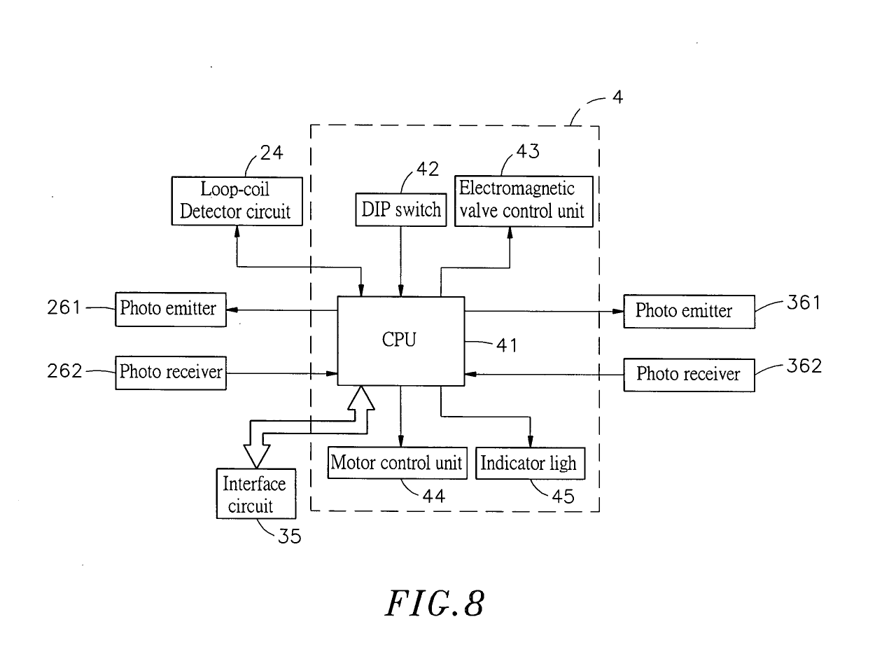

Referring to FIG. 8 and FIGS. 3 and 4 again, the cash receiver further comprises a control circuit 4. The control circuit 4 comprises a CPU (central processing unit) 41 for running computing and control, a DIP (dual in-line package) switch 42 electrically coupled to the CPU 41 for operation and setting controls, an electromagnetic valve control unit 43 electrically coupled to the CPU 41 for controlling the electromagnetic valve 27 of the coin receiver unit 2, a motor control unit 44 electrically coupled to the CPU 41 for controlling the motor drive mechanism 34 of the bill receiver unit 3, and indicator lights 45 electrically coupled to the CPU 41 for message indication. Further, the CPU 41 is electrically coupled to the loop-coil detector circuit 24 and photo emitters 261 and photo receivers 262 of the optical sensor 26 of the coin receiver unit 2, and the interface circuit 35 and photo emitters 361 and photo receivers 362 of the bill receiver unit 3.

Further, the interface circuit 35 of the bill receiver unit 3 is not limited to any particular type. It can be a CCTalk, RS232 or MDB Parallel type interface circuit electrically coupled to the host 5 for signal and data transmission.

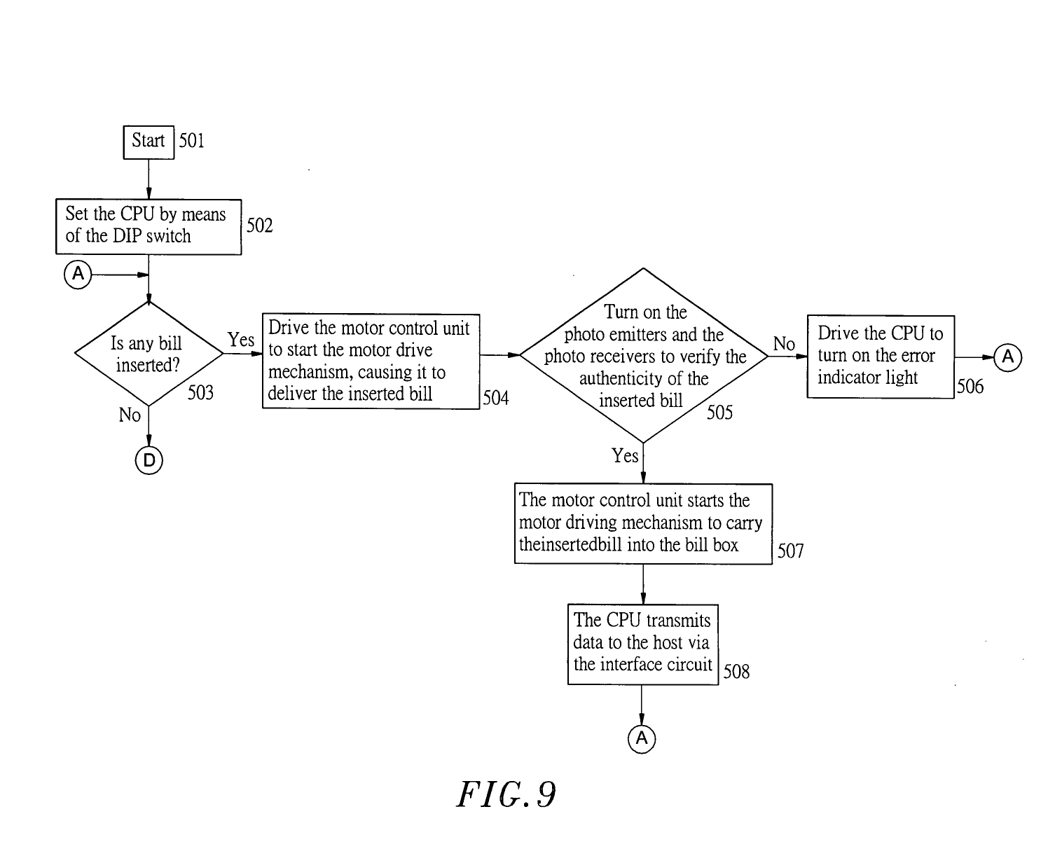

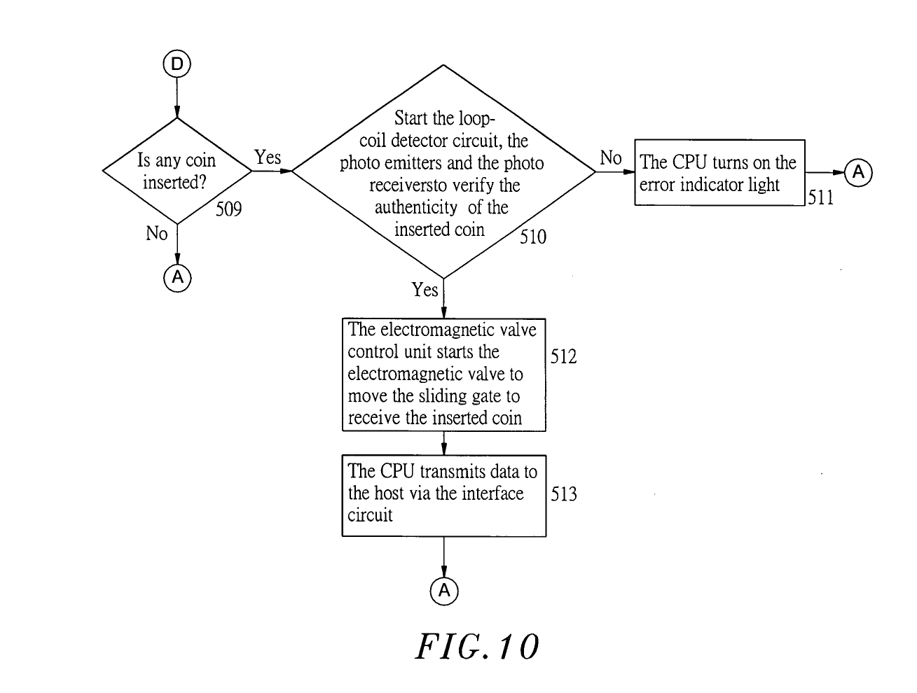

Referring to FIGS. 9 and 10, the control circuit 4 is operated subject to the steps of:
501 Start.
502 Set the CPU 41 by means of the DIP switch 42.
503 Proceed to step 504 when a bill is inserted, or proceed to step 509 via D if no any bill is inserted.
504 Drive the motor control unit 44 to start the motor drive mechanism 34, causing it to deliver the inserted bill.
505 Turn on the photo emitters 361 and the photo receivers 362 to verify the authenticity of the inserted bill, and then proceed to step 507 if the inserted bill is confirmed genuine, or proceed to step 506 if the inserted bill is a counterfeit.
506 Drive the CPU 41 to turn on the error indicator light of the indicator lights 45, and then return to step 503 via A.
507 Drive the motor control unit 44 to start the motor driving mechanism 34, causing the motor drive mechanism 34 to carry the inserted bill into the bill box.
508 Drives the CPU 41 to transmit data to the host 5 via the interface circuit 35, and then return to Step 503 via A.
509 Proceed to step 510 when a coin is inserted, or return to step 503 when no any coin is inserted.
510 Start the loop-coil detector circuit 24, the photo emitters 261 and the photo receivers 262 to verify the authenticity of the inserted coin, and then proceed to step 512 when the inserted coin is confirmed genuine, or proceed to step 511 if the inserted coin is a counterfeit.
511 Drives the CPU 41 to turn on the error indicator light of the indicator lights 45, and then return to step 503 via A.
512 Drive the electromagnetic valve control unit 43 to start the electromagnetic valve 27, thereby moving the sliding gate 271 to receive the inserted coin.
513 Drive the CPU 41 to transmit data to the host 5 via the interface circuit 35, and then return to step 503 via A.

As described above, the DIP switch 42 can be operated to set the CPU 41 of the control circuit 4, and the client can run related operations via the DIP switch 42. When the CPU 41 receives a bill-insertion signal after start of the control circuit 4, it immediately drives the motor control unit 44 to start the motor drive mechanism 34 and the bill acceptor module 36, causing the motor 341, the transmission rollers 342, the transmission belts 343 and the rolling balls 344 of the motor drive mechanism 34 to deliver the inserted bill through the bill passage 33 and the photo emitters 361 and the photo receivers 362 of the bill acceptor module 36 to verify the authenticity of the inserted bill and to give a detection result signal to the CPU 41. If the CPU 41 receives a coin-insertion signal, it drives the loop-coil detector circuit 24 and the photo emitters 261 and the photo receivers 262 of the optical sensor 26 to detect the authenticity and value of the inserted coin, and the photo receivers 262 will give a detection result signal to the CPU 41. When the CPU 41 receives a false coin or false bill signal, it immediately drives the error indicator light of the indicator lights 45 to give a visual indication. If the inserted bill or coin is confirmed to be genuine, the CPU 41 immediately drives the motor drive mechanism 34 or the electromagnetic valve 27 to receive the inserted bill or coin, and transmits the coin or bill value signal to the host 5 via the interface circuit 35.

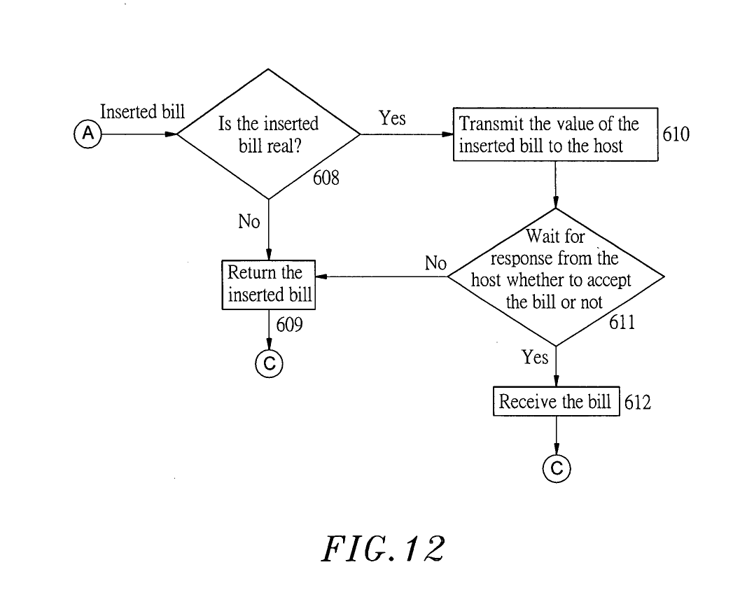

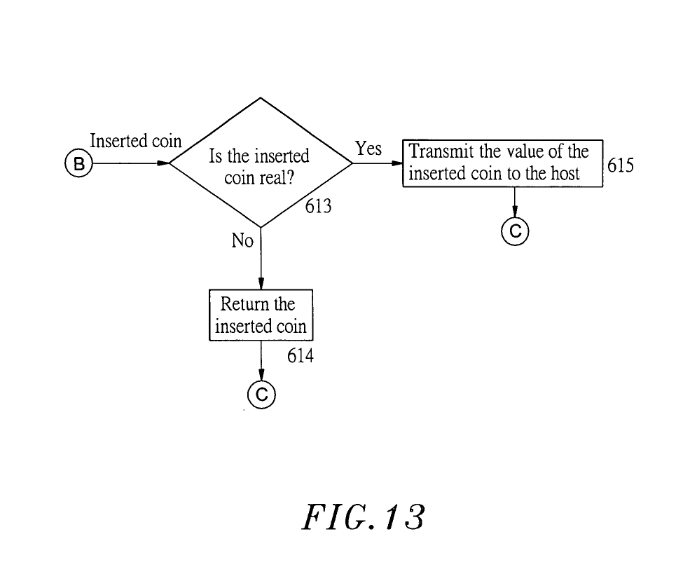

Referring to FIGS. 12 and 13 and FIG. 1 again, the cash receiver operates subject to the following steps:
601 System initialization.
602 Proceed to step 603 if any system error occurs during auto system check, or proceed to step 605 if the system is checked OK.
603 Display the error message of the auto system check. 604 End.
605 Standby, and proceed to step 606 when a bill is inserted or proceed to step 607 when a coin is inserted.
606 Run a bill verification procedure and proceed to step 608 via A.
607 Run a coin verification procedure and proceed to step 613 via B.
608 Judge the authenticity and value of the inserted bill, and then proceed to step 610 if the inserted bill is genuine, or proceed to step 609 if the inserted bill is a counterfeit.
609 Return the inserted bill and then return to step 605 via C.
610 Transmit the value of the inserted bill to the host 5.
611 Wait for response from the host 5 whether or not the host 5 accepts the bill, and then proceed to step 612 if the host 5 accepts the bill, or return to step 609 if the host 5 rejects the bill.
612 Receive the bill in the bill box and then return to step 605 via C.
613 Judge the authenticity and value of the inserted coin, and then proceed to step 615 if the inserted coin is genuine, or proceed to step 614 if the inserted bill is a counterfeit.
614 Return the coin and then return to step 605 via C.
615 Transmit the value of the inserted coin to the host 5, and then return to step 605 via C.

As described above, after system initialization, the system automatically runs system check. In case of a system error, the system displays the error and then ends the operation. When the system is checked OK, it enters standby mode. When a coin or bill is inserted, the system immediately verifies the authenticity and value of the inserted coin or bill. In case a counterfeit coin or bill is inserted, the inserted object is returned. When the inserted coin or bill is checked real, the system gives a signal indicative of the value of the inserted coin or bill to the host 5 and then waist for response. When the host 5 accepts the inserted coin or bill, the system immediately receives the coin or bill in the coin box or bill box and then enters standby mode, and the user can then operate the host 5. If the host 5 rejects the coin or bill, the system immediately returns the coin or bill and then enters standby mode.

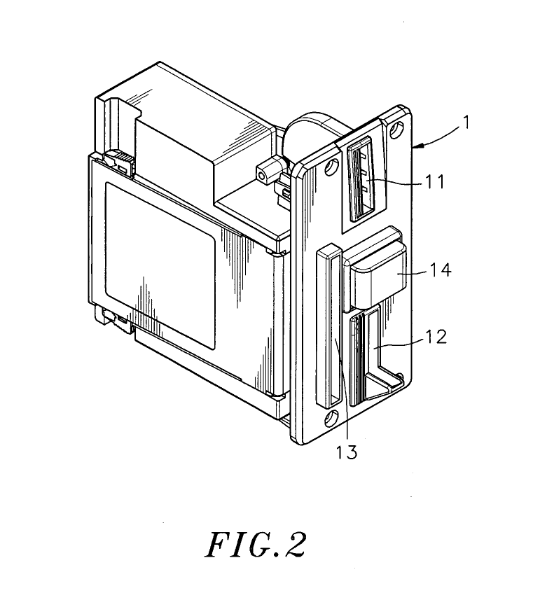

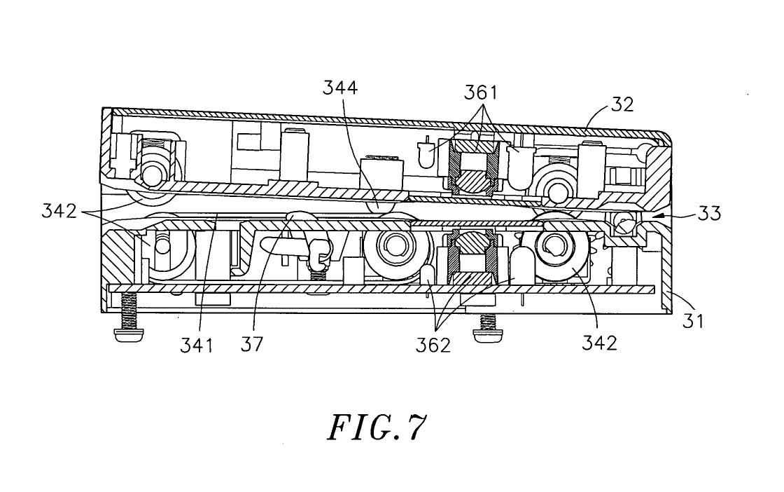

Referring to FIGS. 2, 4 and 7 again, when a coin is inserted into the coin slot 11 of the face panel 1, the inserted coin moves into the coin entrance passage 23 of the coin receiver unit 2, and at the same time the loop-coil detector circuit 24 detects the authenticity and value of the coil by means of magnetic induction. When the inserted coin keeps moving forward toward the bottom side of the coin entrance passage 23, the anti-theft security hook 25 is turned to the close position to prohibit the inserted coin from being pulled back. The coin is then guided by a slope in the coin entrance passage 23 to pass through the optical sensor 26 that verifies the authenticity and value of the coin again, increasing the accuracy of verification. After verification, the coin drops to the top side of the sliding gate 271 of the electromagnetic valve 27. When the inserted coin is a counterfeit, the inserted counterfeit coin will be guided by the sloping surface of the sliding gate 271 into the coin-return passage 28 and then the coin-return slot 12. If the inserted coin is genuine, the sliding gate 271 is moved by the electromagnetic valve 27 to let the inserted coin pass through the coin entrance passage 23 to the coin box.

When a bill is inserted into the bill slot 13 of the face panel 1, the inserted bill will be moved by the motor drive mechanism 34 toward the inside of the bill receiver unit 3, at the same time the bill acceptor module 36 will be driven to verify the authenticity of the inserted bill. If the inserted bill is a counterfeit, the motor drive mechanism 34 will be revered to carry the inserted counterfeit bill to the bill slot 13. It the inserted bill is real, the motor drive mechanism 34 will carry the bill through the anti-theft security hook 37 toward the rear side of the bill passage 33. At this time, the anti-theft security hook 37 prohibits a backward displacement of the bill. When the bill reaches the rear side of the bill passage 33, the bill will be forced into the bill box by the motor drive mechanism 34.

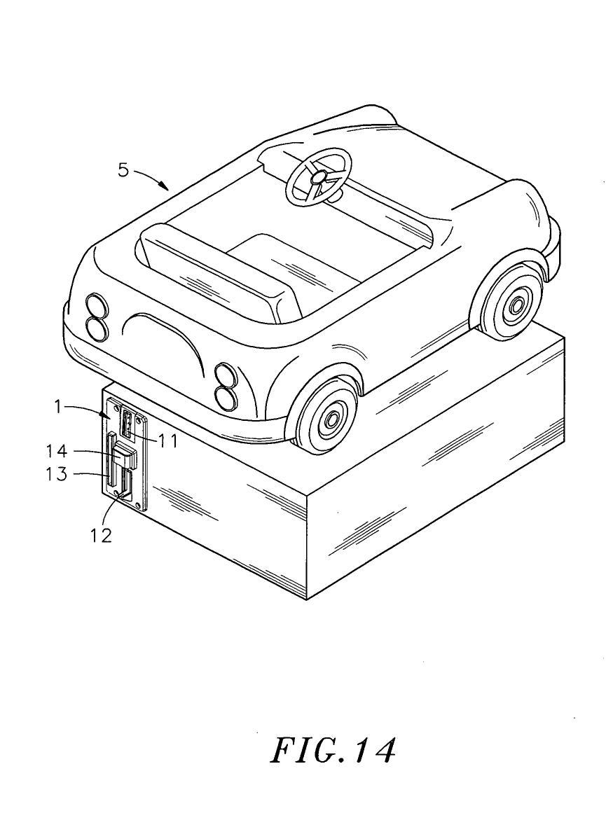

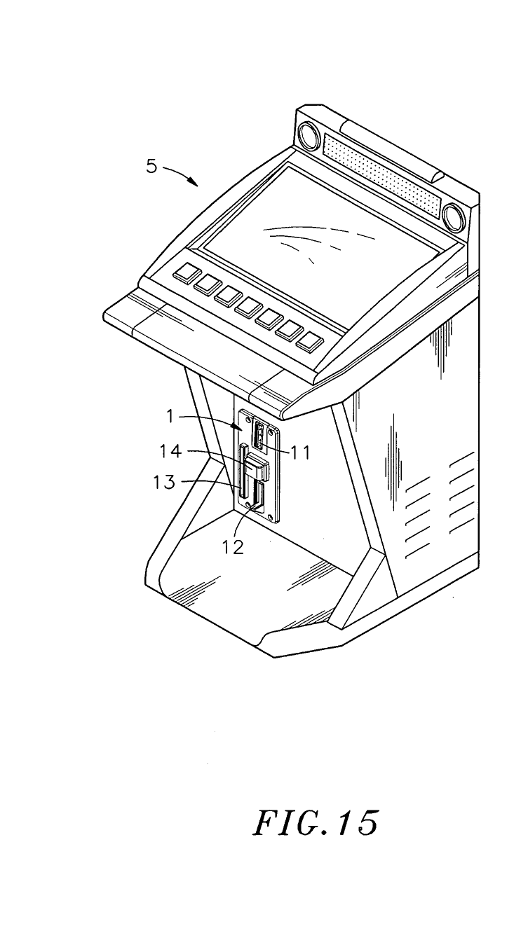

Referring to FIGS. 14 and 15 and FIGS. 1 and 2 again, the host 5 can be a consumption system. The consumption system can be an electric game toy, basketball machine, dancing machine, hose riding machine, driving machine, electronic target, electric dartboard, crane machine, photo shooting machine, pinball machine, Mario series machine or any of a variety of other amusement systems, or a beverage vending machine, tobacco vending machine, ticket vending machine, ice cream vending machines, memorial coin and keyring vending machine, hamburger vending machine, French fry vending machine, noodle vending machine or any of a variety of other automatic vending machines. The client can insert a coin or bill into the cash receiver of the consumption system to start the host 5 and to operate the host 5 subject to the value of the inserted coin or bill. For example, when the parent inserted one coin into a riding machine, the child can ride the riding machine for one cycle. If the parent inserts a bill of which the value is ten times over the assigned coin, the child can then ride the riding machines for ten cycles. By means of the application of the present invention, a consumption system can accept coins as well as bills, providing maximum convenience to the clients. Because of the application of the present invention, the owner of an amusement park or any of a variety of other places where consumption systems made according to the present invention are provided for play needs not to hire an extra serviceman or servicewoman or install a coin change machine for providing a coin change service. Therefore, the owner of amusement park or the like can save much labor cost and coin change machine installation space, realizing a real manless management.

Further, consumption systems may be installed in an arcade, night market or street corner. The number of consumption systems in these areas is limited, and most of the clients of these consumption systems are passersby. In these places, no money exchange service is provided. People must prepare coins when wishing to play games or purchase things from these consumption systems. By means of the application of the present invention, people can insert the bill instead of coins. Therefore, the invention brings convenience to people.

Further, the bill slot 13, the bill receiver unit 3, the coin slot 11 and the coin-return slot 12 as well as the coin receiver unit 2 are of vertical design. Therefore, the coin receiver unit 2 and the bill receiver unit 3 can be set in vertical and abutted against each other and fixedly fastened to the back side of the face panel 1, reducing the size of the cash receiver and saving much the space of the host 5.

As stated above, the invention provides a cash receiver for consumption system that has the following advantages and features:

1. The face panel 1 has a coin slot 11, a coin-return slot 12 and a bill slot 13, and the coin receiver unit 2 and the bill receiver unit 3 are abutted against each other and fixedly fastened to the back side of the face panel 1. When assembled, the cash receiver is installed in the host 5 of a consumption system such that a person can insert a coin or bill into the cash receiver to play the consumption system.

2. After insertion of a bill into the bill slot 13, the bill receiver unit 3 verifies the authenticity and value of the inserted bill. After insertion of a coin into the coin slot 11, the coin receiver unit 2 verifies the authenticity and value of the inserted coin. When a counterfeit bill is inserted, the bill receiver 3 will return the inserted counterfeit bill to the bill slot 13. When a counterfeit coin is inserted, it will be rejected by the coin receiver unit 2 and discharged out of the coin-return slot 12. Because the cash receiver accepts coins as well as bills, the consumption system owner needs not to hide a serviceman or servicewoman or to install a coin change machine for providing a money exchange service.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cash receiver installed in a host for controlling the operation of said host, the cash receiver comprising:
a face panel, said face panel comprising a coin slot, a coin-return slot and a vertical bill slot respectively cut through front and rear sides thereof;
a coin receiver unit affixed to the rear side of said face panel, said coin receiver unit comprising a coin entrance passage connected to said coin slot and a coin-return passage connected to said coin-return slot; and
a bill receiver unit affixed to the rear side of said face panel and abutted against one side of said coin receiver unit, said bill receiver unit comprising a bill passage connected to said vertical bill slot.

2. The cash receiver as claimed in claim 1, wherein said coin receiver unit comprises an anti-theft security hook disposed in said coin entrance passage and adapted to stop backward movement of the inserted coin.

3. The cash receiver as claimed in claim 1, wherein said coin receiver unit comprises an electromagnetic valve, and a gate controllable by said electromagnetic valve to move between a first position for the inserted coin to be moved through said coin entrance passage and a second position for guiding the inserted coin to said coin-return passage.

4. The cash receiver as claimed in claim 1, wherein said bill receiver unit comprises an anti-theft security hook disposed in said bill passage and adapted to stop backward movement of the inserted bill.

5. The cash receiver as claimed in claim 1, wherein said face panel comprises a button for enabling said coin receiver unit to return the inserted coin to said coin-return slot.

6. The cash receiver as claimed in claim 1, wherein said coin receiver unit comprises a loop-coil detector circuit and an optical sensor disposed in said coin entrance passage for verifying the authenticity and value of the inserted coin.

7. The cash receiver as claimed in claim 1, wherein said bill receiver unit comprises a bill acceptor module installed in said bill passage for verifying the authenticity and value of the inserted bill.

8. The cash receiver as claimed in claim 1, further comprising a control circuit installed in said coin receiver unit and said bill receiver unit, said control circuit comprising a central control unit that controls said coin receiver unit to verify the authenticity and value of the inserted coin and return the counterfeit coin and said bill receiver unit to verify the authenticity and value of the inserted bill and return the counterfeit bill, a DIP (dual in-line package) switch electrically coupled to said central processing unit for operation and setting controls, and indicator light means electrically coupled to said central processing unit for message indication.

9. The cash receiver as claimed in claim 8, wherein said bill receiver unit comprises a motor drive mechanism controllable to deliver the inserted bill; said control circuit comprises a motor control unit electrically coupled to said central processing unit for controlling the operation of said motor drive mechanism.

10. The cash receiver as claimed in claim 8, wherein said bill receiver unit comprises an interface circuit electrically coupled to said central processing unit of said control circuit for data transmission between said central processing unit and said host.

11. The cash receiver as claimed in claim 8, wherein said control circuit comprises an electromagnetic valve control unit electrically coupled to said central processing unit for controlling said coin receiver unit to receive the inserted coin and to return the counterfeit coin.

12. The cash receiver as claimed in claim 1, wherein said host is one of the game machines of electric game toy, basketball machine, driving machine, electronic target, electric dartboard, crane machine, photo shooting machine and pinball machine and the vending machines of beverage vending machine, tobacco vending machine, ticket vending machine, ice cream vending machines, memorial coin and keyring vending machine, hamburger vending machine, French fry vending machine and noodle vending machine.
